(19) United States
(12) Patent Application Publication
(10) Pub. No.: US 2013/0205378 A1
(43) Pub. Date: Aug. 8, 2013

(54) COMMUNICATION APPARATUS, SERVER APPARATUS, RELAY APPARATUS, CONTROL APPARATUS, AND COMPUTER PROGRAM PRODUCT

(71) Applicant: KABUSHIKI KAISHA TOSHIBA, TOKYO (JP)

(72) Inventors: Yoshihiro Oba, Kanagawa-ken (JP); Yoshiki Terashimai, Kanagawa-ken (JP)

(73) Assignee: KABUSHIKI KAISHA TOSHIBA, TOKYO (JP)

(21) Appl. No.: 13/719,914

(22) Filed: Dec. 19, 2012

(30) Foreign Application Priority Data
Feb. 3, 2012 (JP) 2012-021963

(51) Int. Cl. G06F 21/44

(52) U.S. Cl. CPC G06F 21/44
USPC 726/7

(57) ABSTRACT

According to an embodiment, a communication apparatus is connected to a server apparatus that issues first authentication information used in communication. The communication apparatus includes a receiving unit configured to receive an execution instruction to execute a bootstrap authentication process of issuing the first authentication information. The bootstrap authentication process includes validation of capability information indicating a capability of the communication apparatus. The communication apparatus also includes a first authentication processing unit configured to execute the bootstrap authentication process with the server apparatus based on second authentication information including the capability information, when the receiving unit receives the execution instruction.

### CROSS-REFERENCE TO RELATED APPLICATION

This application'is based upon and claims the benefit of priority from Japanese Patent Application No. 2012-021963, filed on Feb. 3, 2012; the entire contents of which are incorporated herein by reference.

### FIELD

Embodiments described herein relate generally to a communication apparatus, a server apparatus, a relay apparatus, a control apparatus, and a computer program product.

### BACKGROUND

In a Wi-Fi protected setup (WPS), authentication information (credential) required when a wireless local area network (LAN) terminal accesses a predetermined wireless LAN access point is set on a communication path encrypted through the minimum user's operations. In the WPS, remote bootstrap, mutual authentication in bootstrap connection, and push-button setting are supported by separating a registration server and a wireless LAN access point. The remote bootstrap is a function of setting a credential in a terminal even when a registration server is located at a place physically remote from a wireless LAN. In this case, the wireless LAN access point has a function of relaying apparatus registration information between a wireless LAN terminal and a registration server. The push button setting is a function of setting a credential in a wireless LAN terminal merely by pushing both setting buttons of a registration server and a wireless LAN terminal.

However, a push button setting mode of the WPS does not support mutual authentication. Therefore, the encrypted communication path is sometimes terminated at a relay node once. In this case, there is a problem that the credential is wiretapped in the relay node and the relay node is thus vulnerable to the Man-in-The-Middle (MiTM) attack. Further, in the WPS, information regarding ability information (apparatus capability) of an apparatus, such as information regarding the fact that a communication apparatus receives predetermined apparatus authentication (for example, ECHONET (registered trademark) Lite apparatus authentication) of an air-conditioner or a storage battery, may not be validated. For this reason, there is a probability that a credential may be set even in a communication apparatus that is originally not permitted to be connected in terms of the apparatus capability. As a result, there is a problem that the physical security of a system may deteriorate in terms of the control purpose of an energy apparatus such as a home energy management system (HEMS).

### BRIEF DESCRIPTION OF THE DRAWINGS

FIG. 1 is a block diagram illustrating a communication system according to a first embodiment;

FIG. 2 is a block diagram illustrating a communication apparatus according to the first embodiment;

FIG. 3 is a block diagram illustrating an apparatus registration server according to the first embodiment;

FIG. 4 is a block diagram illustrating an apparatus control apparatus according to the first embodiment;

FIG. 5 is a diagram illustrating a sequence of a bootstrap communication process according to the first embodiment;

FIG. 6 is a diagram illustrating a sequence of a normal communication process according to the first embodiment;

FIG. 7 is a block diagram illustrating a communication system according to a second embodiment;

FIG. 8 is a block diagram illustrating an apparatus registration relay according to the second embodiment;

FIG. 9 is a diagram illustrating a sequence of a bootstrap communication process according to the second embodiment;

FIG. 10 is a block diagram illustrating a communication system according to a third embodiment;

FIG. 11 is a block diagram illustrating an adapter according to the third embodiment;

FIG. 12 is a block diagram illustrating an apparatus according to the third embodiment;

FIG. 13 is a diagram illustrating a sequence of a bootstrap communication process according to the third embodiment;

FIG. 14 is a block diagram illustrating an adapter according to a fourth embodiment;

FIG. 15 is a diagram illustrating a sequence of a bootstrap communication process according to the fourth embodiment;

FIG. 16 is a block diagram illustrating a communication system according to a fifth embodiment; and

FIG. 17 is a diagram illustrating a hardware configuration of the apparatus according to the first to fifth embodiments.

### DETAILED DESCRIPTION

According to an embodiment, a communication apparatus is connected to a server apparatus that issues first authentication information used in communication. The communication apparatus includes a receiving unit configured to receive an execution instruction to execute a bootstrap authentication process of issuing the first authentication information. The bootstrap authentication process includes validation of capability information indicating a capability of the communication apparatus. The communication apparatus also includes a first authentication processing unit configured to execute the bootstrap authentication process with the server apparatus based on second authentication information including the capability information, when the receiving unit receives the execution instruction.

Hereinafter, communication apparatuses according to preferred embodiments of the present invention will be described in detail with reference to the accompanying drawings.

### First Embodiment

A communication apparatus according to a first embodiment executes a bootstrap authentication process with an apparatus registration server based on a preset bootstrap credential (second authentication information). The bootstrap authentication process refers to an authentication process of causing the communication apparatus to issue authentication information (operational credential: first authentication information) used in communication with another apparatus (such as a server apparatus or an apparatus control apparatus). Thus, even when a push button is configured, end-to-end setting can be set for an encrypted communication path between the communication apparatus and the apparatus registration server. Accordingly, it is possible to prevent the MiTM attack in which a credential is wiretapped in a relay node.

The bootstrap credential and the operational credential (first authentication information) are configured to include information used to specify an apparatus capability. Thus, the information regarding an apparatus capability can be validated. Accordingly, the physical security of a target system can be improved by not setting a credential in a communication apparatus that is not permitted to be connected in regard to the apparatus capability.

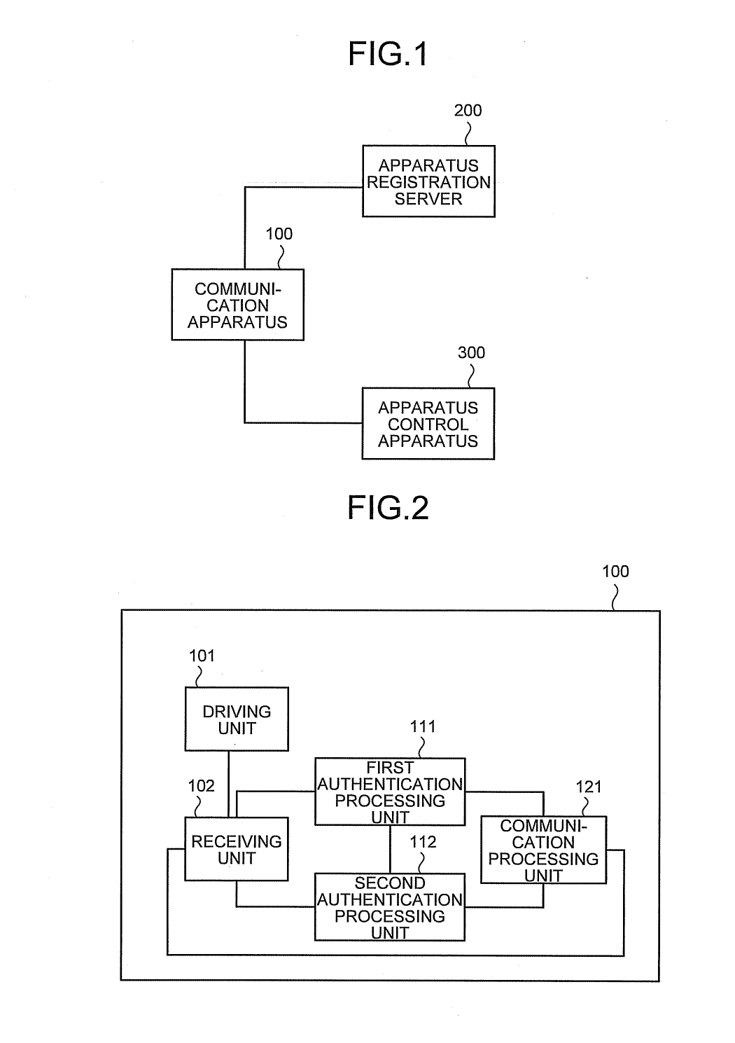

FIG. 1 is a block diagram illustrating an example of the configuration of a communication system according to the first embodiment. The communication system according to this embodiment includes a communication apparatus 100, an apparatus registration server 200 serving as a server apparatus, and an apparatus control apparatus 300 serving as a control apparatus.

Each media access control (MAC) layer and each physical layer in the communication apparatus 100 and the apparatus registration server 200 and in the communication apparatus 100 and the apparatus control apparatus 300 may be realized in conformity with a communication protocol such as a wired LAN, a wireless LAN, Bluetooth (registered trademark), or ZigBee (registered trademark). The bootstrap credential, which is the authentication information exchanged between the communication apparatus 100 and the apparatus registration server 200, and the operational credential, which is the authentication information used in normal communication and exchanged between the communication apparatus 100 and the apparatus control apparatus 300, may be exchanged in conformity with a protocol of any layer of the data link layer, the network layer, the transport layer, and the application layer. When the authentication information is exchanged with the data link layer, a protocol such as IEEE 802.1X or IEEE 802.15.9 may be used. When the authentication information is exchanged in conformity with a protocol of an upper layer of the data link, RFC 5191, the internet key exchange version 2 (IKEv2), or transport layer security (TLS) may be used.

Before the bootstrap authentication process is executed, for example, when the communication apparatus 100 is manufactured, set in a factory, or sold, the bootstrap credential is set in the communication apparatus 100 in accordance with a scheme (an encryption scheme or a scheme of dividing a bootstrap credential into small blocks and dispersing and recording the blocks in a broad range of a storage area) in which a user of the communication apparatus 100 may not easily gain access. Further, the bootstrap credential once set in the communication apparatus 100 may be updated. In this case, when software of the communication apparatus 100 is updated, the bootstrap credential may be updated by inserting an updated bootstrap credential in the updated software.

FIG. 2 is a block diagram illustrating an example of the configuration of the communication apparatus 100 according to the first embodiment. As illustrated in FIG. 2, the communication apparatus 100 includes a driving unit 101, a receiving unit 102, a first authentication processing unit 111, a second authentication processing unit 112, and a communication processing unit 121.

The communication processing unit 121 controls communication with an external apparatus in conformity with any communication protocol such as a wired LAN, a wireless LAN, Bluetooth (registered trademark), or ZigBee (registered trademark), as described above.

The driving unit 101 executes driving by hardware and software. The bootstrap authentication process starts, when the driving unit 101 executes driving. The driving unit 101 can be realized by, for example, a hardware or software driving bootstrap button. The driving unit 101 generates a push-button event, when the driving unit 101 is pressed down by a user.

The receiving unit 102 receives an instruction to execute the bootstrap authentication process. For example, the receiving unit 102 receives the push-button event generated by the driving unit 101 as an execution instruction. The receiving unit 102 transmits the received execution instruction (push-button event) to the first authentication processing unit 111 and the second authentication processing unit 112.

When the software driving bootstrap button is configured, a push-button event may be generated from a remote device such as a remote controller or an RFID tag through the communication processing unit 121. In this case, the receiving unit 102 receives the push-button event transmitted from the remote device as an execution instruction.

When the hardware driving bootstrap button is configured, the driving unit 101 may include a movable portion. In this case, the driving unit 101 executes the driving, when the user pushes the movable portion with his or her hand. When the driving unit 101 includes no movable portion, the driving unit 101 may be configured to execute the driving through an operation such as touching of a part of the body of the user to the driving unit 101. When the driving unit 101 includes a sound input interface, the driving unit 101 may be configured to execute the driving through an action of utterance or clapping sound, or the like of the user.

The first authentication processing unit 111 executes the bootstrap authentication process with the apparatus registration server 200 based on the bootstrap credential. For example, when the first authentication processing unit 111 receives the push-button event, the first authentication processing unit 111 starts the bootstrap authentication process with the apparatus registration server 200 through the communication processing unit 121. When the bootstrap authentication process successfully ends, the first authentication processing unit 111 transmits the operational credential acquired from the apparatus registration server 200 to the second authentication processing unit 112. When the first authentication processing unit 111 receives the push-button event and a given time (Walk Time) elapses, the bootstrap authentication process ends in spite of the fact that the bootstrap authentication process is being executed.

The second authentication processing unit 112 executes a communication authentication process of establishing communication with an external apparatus such as the apparatus control apparatus 300 with the external apparatus based on the operational credential. For example, when the second authentication processing unit 112 retains the operational credential and the communication apparatus is not connected to the apparatus control apparatus 300, the second authentication processing unit 112 starts the communication authentication process. When the second authentication processing unit 112 receives the push-button event, the second authentication processing unit 112 prohibits the communication authentication process performed with the apparatus control apparatus 300 through the communication processing unit 121 during a given time and immediately ends the communication authentication process being in progress.

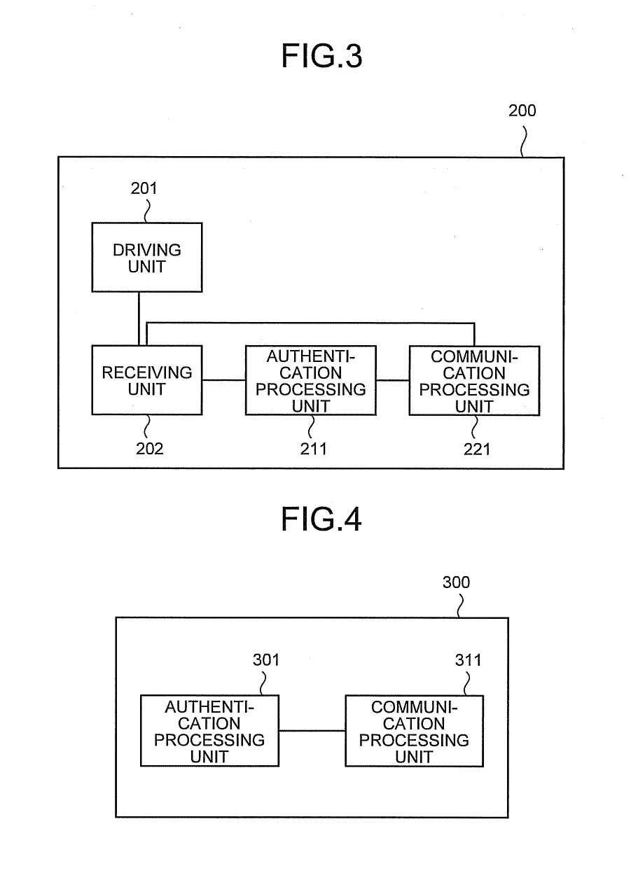

FIG. 3 is a block diagram illustrating an example of the configuration of the apparatus registration server 200 according to the first embodiment. As illustrated in FIG. 3, the apparatus registration server 200 includes a driving unit 201, a receiving unit 202, an authentication processing unit 211, and a communication processing unit 221.

The communication processing unit 221 controls communication with an external apparatus in conformity with any communication protocol such as a wired LAN, a wireless LAN, Bluetooth (registered trademark), or ZigBee (registered trademark).

The driving unit 201 executes driving by hardware and software. The receiving unit 202 receives an instruction to execute the bootstrap authentication process. Since the configurations of the driving unit 201 and the receiving unit 202 are the same as those of the driving unit 101 and the receiving unit 102 of the communication apparatus 100, the description thereof will not be repeated.

When the authentication processing unit 211 receives a push-button event from the receiving unit 202, the authentication processing unit 211 starts the bootstrap authentication process with the communication apparatus 100 through the communication processing unit 221. When the authentication processing unit 211 receives the push-button event and a given time elapses, the authentication processing unit 211 ends the bootstrap authentication process in spite of the fact that the bootstrap authentication process is being executed.

FIG. 4 is a block diagram illustrating an example of the configuration of the apparatus control apparatus 300 according to the first embodiment. As illustrated in FIG. 4, the apparatus control apparatus 300 includes an authentication processing unit 301 and a communication processing unit 311.

The communication processing unit 311 controls communication with an external apparatus in conformity with any communication protocol such as a wired LAN, a wireless LAN, Bluetooth (registered trademark), or ZigBee (registered trademark). The authentication processing unit 301 executes a communication authentication process with the communication apparatus 100 through the communication processing unit 311 based on the operational credential.

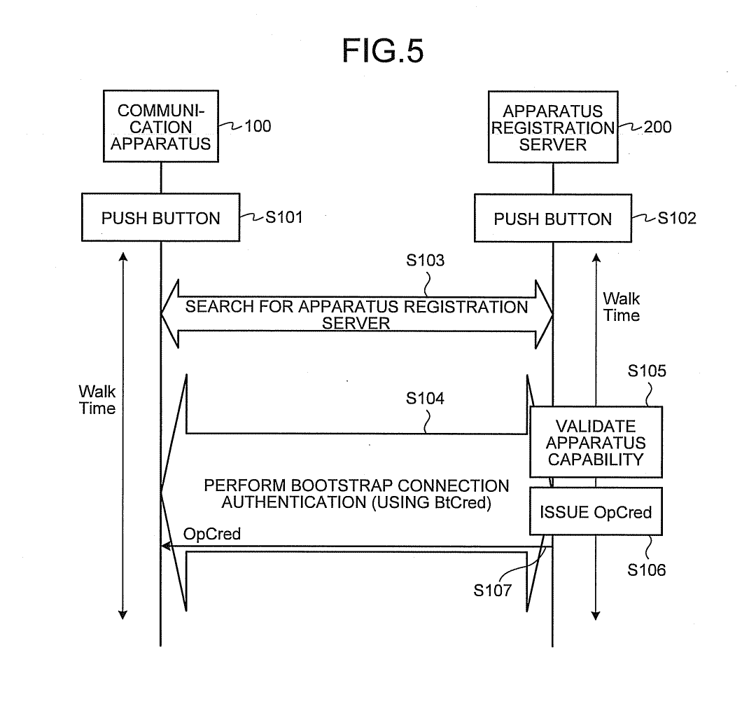

Next, the bootstrap communication process executed between the communication apparatus 100 and the apparatus registration server 200 having the above-described configurations according to the first embodiment will be described. FIG. 5 is a diagram illustrating a sequence of an example of the bootstrap communication process according to the first embodiment.

When the bootstrap buttons of the communication apparatus 100 and the apparatus registration server 200 are driven through a user's operation (step S101 and step S102), the communication apparatus 100 and the apparatus registration server 200 validate transmission and reception of the bootstrap credential during a given time (Walk Time). The communication apparatus 100 first executes a sequence for detecting an apparatus registration server in order to detect a communicable address of the apparatus registration server 200 during a given time (step S103). The dynamic host configuration protocol (DHCP), the domain name system (DNS), and the universal plug and play (UPnP) may be used to detect the apparatus registration server.

Next, the communication apparatus 100 executes the bootstrap authentication process with the apparatus registration server 200 based on a bootstrap credential (BtCred) (step S104). During the bootstrap authentication process, the communication apparatus 100 establishes an encrypted secure communication path with the apparatus registration server 200. The communication apparatus 100 transmits the apparatus capability of the communication apparatus itself to the apparatus registration server 200 along the established secure communication path. When the bootstrap credential includes a digital certificate and the communication apparatus 100 establishes the encrypted secure communication path with the apparatus registration server 200, the communication apparatus 100 may transmit, to the apparatus registration server 200, a bootstrap authentication request message signed with a secret key corresponding to the certificate of the communication apparatus itself including the apparatus capability of the communication apparatus itself. In this case, it is not necessary to transmit the apparatus capability along the established secure communication path. Further, when the bootstrap credential includes an identify-based encryption (IBE) credential and the communication apparatus 100 establishes the encrypted secure communication path with the apparatus registration server 200, the communication apparatus 100 may transmit, to the apparatus registration server 200, the ID of the communication apparatus itself including the apparatus capability of the communication apparatus itself. In this case, it is not necessary to transmit the apparatus capability along the established secure communication path.

The apparatus registration server 200 validates the apparatus capability received from the communication apparatus 100 (step S105). When the validation of the apparatus capability succeeds, the apparatus registration server 200 issues the operational credential (OpCred) including the apparatus capability (step S106). The apparatus registration server 200 transmits the issued operational credential to the communication apparatus 100 along the secure communication path (step S107). Thus, the bootstrap authentication process successfully ends.

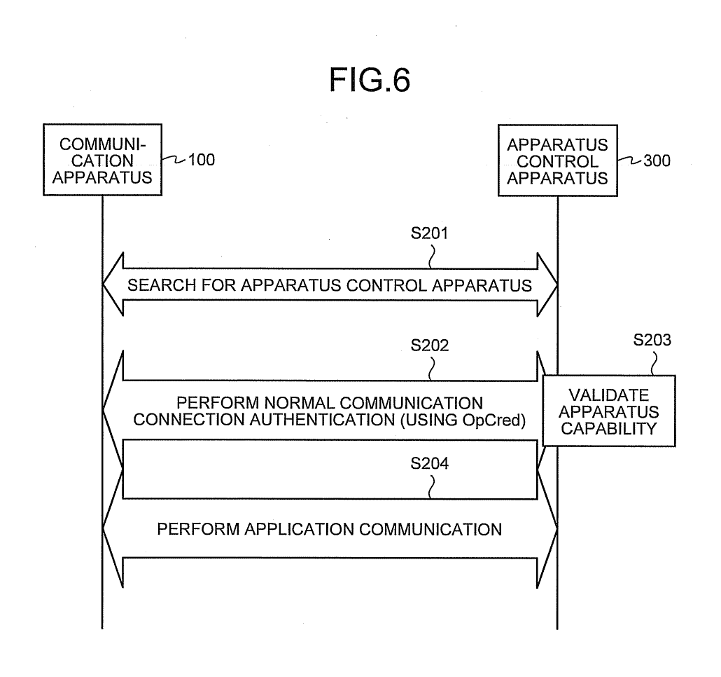

Next, a normal communication process executed between the communication apparatus 100 and the apparatus control apparatus 300 having the above-described configurations according to the first embodiment will be described. FIG. 6 is a diagram illustrating a sequence of an example of the normal communication process according to the first embodiment.

In FIG. 6, the communication apparatus 100 is assumed to acquire an operation credential from the apparatus registration server 200.

The communication apparatus 100 first executes a sequence for searching for an apparatus control apparatus in order to obtain a communicable address of the apparatus control apparatus 300 (step S201). The DHCP, the DNS, and the UPnP may be used to search for the apparatus control apparatus. Next, the communication apparatus 100 executes a communication authentication process with the apparatus control apparatus 300 based on the operational credential (OpCred) (step S202). During the communication authentication process, the communication apparatus 100 establishes an encrypted secure communication path with the apparatus control apparatus 300 and transmits the apparatus capability of the communication apparatus itself to the apparatus control apparatus 300 along the secure communication path. When the operational credential includes a digital certificate and the communication apparatus 100 establishes the encrypted secure communication path with the apparatus control apparatus 300, the communication apparatus 100 may transmit, to the apparatus control apparatus 300, a communication authentication request message signed with a secret key corresponding to the certificate of the communication apparatus itself including the apparatus capability of the communication apparatus itself. In this case, it is not necessary to transmit the apparatus capability along the established secure communication path. Further, when the operational credential includes an IBE credential and the communication apparatus 100 establishes the encrypted secure communication path with the apparatus control apparatus 300, the communication apparatus 100 may transmit, to the apparatus control apparatus 300, the ID of the communication apparatus itself including the apparatus capability of the communication apparatus itself. In this case, it is not necessary to transmit the apparatus capability along the established secure communication path.

The authentication processing unit 301 of the apparatus control apparatus 300 validates the apparatus capability received from the communication apparatus 100 (step S203). When the validation of the apparatus capability succeeds, the communication authentication process successfully ends. Further, the communication authentication process and network access authentication may be integrated. For example, RFC 5191 used in the network access authentication of ZigBee IP may be used in the communication authentication process and the network access authentication. In this case, the success of the network access authentication of ZigBee IP in conformity with RFC 5191 also means success of the communication authentication process. After the communication authentication process succeeds, the communication apparatus 100 executes application communication with the apparatus control apparatus 300 (step S204).

The communication apparatus 100 may be mounted on a household electronic appliance, a smart meter, an electric vehicle, and a solar panel. The apparatus registration server 200 may be mounted on a HEMS server, a smart meter, a power company server, an Internet service provider server, a concentrator, a router, a wireless LAN access point, and a LAN switch. The apparatus control apparatus 300 may be mounted on a HEMS server, a personal computer (PC), a tablet terminal, and a cellular phone. The bootstrap credential may be embedded in an IC card (smart card).

A symmetric key credential, a public key credential, or an IBE credential may be used as the bootstrap credential. In general, the bootstrap authentication process is basically executed in a mutual authentication manner. The bootstrap credential may be configured to include authentication information (for example, a public key of a certificate authority that both the communication apparatus 100 and the apparatus registration server 200 trust) required to authenticate the apparatus registration server 200. The bootstrap credential includes an apparatus capability.

A symmetric key credential, a public key credential, or an IBE credential may be used as the operational credential. Further, the operational credential includes an apparatus capability.

An apparatus identifier or an apparatus profile identifier can be exemplified as the apparatus capability included in the bootstrap credential and the operational credential. The apparatus identifier may include an apparatus maker name, a kind of apparatus, and an apparatus model number. For example, the kind of apparatus may be a letter string such as “airconditioner”. The apparatus profile identifier may be a letter string or may be hierarchically set. For example, when the communication apparatus 100 is an air conditioner corresponding to ECHONET (registered trademark), a letter string “echonet.airconditioner” formed such that “echonet” is classified in a higher profile item and “airconditoner” is classified in a lower profile item can be used as the apparatus profile identifier. The bootstrap credential may include a unique apparatus identifier (for example, manufacture's serial number), a rated voltage, a rated current, or a power frequency for each communication apparatus 100.

An extensible authentication protocol (EAP) defined in RFC 3748 may be used as an authentication protocol for the bootstrap authentication process. In this case, a protocol for carrying authentication for network access (PANA) defined in RFC 5191, an IKEv2 defined in RFC 4306, or an IEEE 802.1X may be used as an EAP transport.

When the IBE credential is used, an ID may include the apparatus capability or information indicating a valid period of the ID. For example, a letter string, “foo@example.com allocated_date=20150101 expiration date=20151231 capability=ECHONET.airconditioner”, may be used as the ID. For example, when the ID includes the valid period, an apparatus authenticated with the IBE credential can execute communication only for the valid period. Further, when the IBE credential is used, EAP-IBE-based mutual authentication (IMA) to be described below may be used as a mutual authentication method.

Further, the bootstrap authentication process and the network access authentication may be integrated. For example, when RFC 5191 used in the network access authentication of ZigBee IP is used in the bootstrap authentication process and the network access authentication, the success of the network access authentication of ZigBee IP in conformity with RFC 5191 also means success of the bootstrap authentication process.

A secure communication path created by an attribute encryption mechanism provided by an EAP authentication method such as the EAP-IMA or an EAP-TLS designated by RFC 5216 to be described below may be used as a secure communication path used to transmit the operational credential. Further, a secure communication path may be used which is created by an attribute encryption mechanism defined by http://tools.ietf.org/html/draft-yegin-pana-encr-avp-01 or http://tools.ietf.org/id/draft-ohba-pana-keywrap-04.txt.

Next, a mutual authentication method based on the IBE credential will be described below. The IBE uses a bilinear map called a pairing function. In the bilinear mapping, two points on a given elliptic curve vary to elements of a given finite F. In general, when a given mapping e is a pairing function, e(aP, bQ)=e(P, Q)^{ab} satisfied. Here, a and b are any integers and P and Q are points on the elliptic curve. Examples of the pairing function include Tate pairing and Veil pairing.

Hereinafter, “<a1, a2, . . . , aN>” represents N pairs of values a1, a2, aN. Further, “s1|s2|. . . |sN” represents a connection of a letter string s1, s2, . . . sN.

The IBE includes three functional elements, that is, an encryption entity, a decryption entity, and a key generation center. The encryption entity and the decryption entity are called users.

When the IBE credential is used in the bootstrap credential, for example, the key generation center corresponds to a server (not illustrated) managed by a manufacturer or an accreditation organization. Further, the encryption entity and the decryption entity correspond to the communication apparatus 100 and the apparatus registration server 200. When the IBE credential is used in the operational credential, the key generation center corresponds to the apparatus control apparatus 300. The encryption entity and the decryption entity correspond to the communication apparatus 100 and the apparatus control apparatus 300.

In the following description, a parameter (elliptic curve indicator) used to uniquely designate an elliptic curve is assumed to be set in advance in each user and a key generation center. The term “elliptic curve” refers to an elliptic curve corresponding to a common elliptic curve indicator set in advance in each user and the key generation center.

An IBE algorithm generally includes four phases, that is, initial setting (Setup), private key generation (Extract), Encryption, and Decryption.

The setup phase is an initialization process of the key generation center and a process closed in the key generation center. At the setup phase, the key generation center generates a master private key s and a key generation center public key Ppub=sP. Here, P is a fixed point on the elliptic curve.

The extract phase is an initialization process of a user. At the extract phase, the user acquires an identifier ID of the user expressed by a byte string, a private key k_ID, Ppub, and P from the key generation center along the encrypted secure communication path.

The key generation center generates k_ID as K_ID=s·K_ID. Here, the ID is the identifier of the user, K_ID is a public key of the identifier ID given as K−ID=H1(ID), and H1( )is hash function. Further, a part or the entirety of the byte string of the ID can be designated by the user.

The encryption phase is an encryption process of the encryption entity. At the encryption phase, the encryption entity generates a random number r and transmits E[b, M]=<rP, C> to the decryption entity. Here, b is an identifier of the decryption entity, M is plain data, and C is encrypted data of the plain data M. For example, when Sakai-Kasahara key exchange (SAKKE) is used in the IBE algorithm, C=M+H2(e(rK_b, Ppub)) is calculated. Here, H2( )denotes the hash function. In the pairing function E, the Tate-Lichtenbaum pairing function is used. Further, r is the random number generated by the encryption entity, and K_b is K_ID when ID=b, that is, is a public key of the decryption entity b. Furthermore, rK_b denotes a product of r and K_b.

The decryption phase is a decryption process of the decryption entity. At the decryption phase, the decryption entity decrypts the plain data M using <rP, C> received from the encryption entity. For example, when SAKKE is used in the IBE algorithm, “M=E⁻¹[b, <rP, C>]=C−H2 (e(K_b, rP))” is used.

Next, IMA which is a mutual authentication protocol using the IBE algorithm will be described.

The IMA has two types of modes, that is, a main mode in which mutual authentication is completed by 1.5 message reciprocations and a puzzle mode in which mutual authentication is completed by 2 message reciprocations. The puzzle mode has resistance against the denial of service (Dos) attack.

Hereinafter, message exchange of each mode will be defined. “A→B: X” means that a message with contents X is transmitted from A to B. The IMA to be described below operates for any IBE algorithm that uses an encryption function of a format “E[x, M]=<rP, C>” (where C is encrypted data of the plain data M).

The mutual authentication of the main mode is defined as follows.

A→B: <a, N_a>

A←B: E[a, b|N_a|N_b|attr_b]

A→B: E[b, N_b|attr_a]

Here, it is assumed that A is an initiator, B is a responder, a is an identifier of the initiator, b is an identifier of the responder, N_x is a random byte series of an identifier x (where x is a or b), and attr_x is an attribute list of the entity of the identifier x (where x is a or b).

When an output of the encryption function E received from a partner is not able to be decrypted using the second and third messages of the main mode or the random byte series generated by an apparatus itself is not included in a predetermined position of the decrypted byte series, the authentication is assumed to succeed.

The mutual authentication of the puzzle mode is defined as follows.

A→B: <a, N_a>

A←B: <b, N_b, puzzle>

A→B: <solution, E[b, a|N_a|N_{—l b|attr}_a]>

A←B: E [a, N_a|attr_b]

Here, puzzle indicates a problem generated by the responder and solution indicates an answer to the puzzle. The other expressions are the same as those of the main mode.

The responder receives a correct solution to the puzzle from the initiator and generates the state of the initiator for the first time. When the solution is not correct, the second message of the puzzle mode is destroyed by the responder.

When an output of the encryption function E received from a partner is not able to be decrypted using the third and fourth messages of the main mode or the random byte series generated by an apparatus itself is not included in a predetermined position of the decrypted byte series, the authentication is assumed to succeed.

Puzzle is expressed in <puzzle type, puzzle_content>. Here, puzzle_type is a kind of problem and puzzle_content is a content of the problem.

As an example of the problem designated by puzzle, a cookie puzzle is present in which a random value is included in puzzle_content and a solution is considered to be correct when the random value is included in the solution. Further, as another example of the problem designated by puzzle, a pairing puzzle is present in which in a given pairing function E, a solution is considered to be correct when solution=e(a1, a2) is satisfied for puzzle_content=<a1, a2>.

Here, attr_a or attr_b may include the apparatus capability, the operational credential, or an encryption key used in encryption of a data link protocol such as IEEE 802.15.4 and an application layer protocol such as a network time protocol (NTP), and a subordinate attribute (a key ID, a key lifetime, a replay counter initial value, and the like).

Next, the EAP-IMA which is an EAP authentication method using the above-described IMA will be described. Message exchange of the EAP-IMA is defined as follows.

A←B: EAP-Request/IBE#1 {<b, N_b>}

A→B: EAP-Response/IBE#2 {E[b, a|N_a|N_b|attr_a]}

A←B: EAP-Request/IBE#3 {<E[a, N_a|attr_b], Finished_S>}

A→B: EAP-Response/IBE#4 {Finished_P}

A←B: EAP-Success

Here, it is assumed that A is an EAP peer and B is an EAP server. When the EAP-IMA is used in the bootstrap authentication process, for example, the communication apparatus 100 corresponds to the EAP peer and the apparatus registration server 200 corresponds to the EAP server. When the EAP-IMA is used in the communication authentication process, for example, the communication apparatus 100 corresponds to the EAP peer and the apparatus control apparatus 300 corresponds to the EAP server.

IBE#i is an i-th payload of the EAP-IMA method. Finished S is a byte series calculated as Finished_S=Hash(k_m, IBE#1|IBE#2). Finished_P is a byte series calculated as Finished_P=Hash(k_m, IBE#1|IBE#2|IBE#3). Here, k_m is an EAP-IMA message authentication key and Hash( )is the hash function. For example, HMAC-SHA1 can be applied as the hash function.

Next, a key generated by the EAP-IMA will be described. First, a master key MK of the EAP-IMA is calculated as follows.

MK'KDF (DHS, Na|Nb, 64+64+L)

Here, KDF is a key derivation function that can generate a byte series with any size. In KDF, it is assumed that a first parameter is a key generation key, a second parameter is a key label, and a third parameter is a byte length of the generated byte series. It is assumed that L is the byte length of k_m and DHS is the Diffie-Hellman symmetric key, which is calculated as follows.

DHS=Qx

Here, it is assumed that Qx is the x coordinate value of a point Q on an elliptic curve in which Q=r_a·r_b·P is satisfied. Here, it is assumed that r_a is a random value of the IMA generated in the encryption function E when the EAP peer generates IBE#2 and r_b is a random value of the IMA generated in the encryption function E when the EAP server generates IBE#3.

Further, it is assumed that km, and a master session key (MSK) and an extended MSK (EMSK) of the EAP are calculated from DHS as follows.

(MSK, EMSK, k_m)=(MK[0, 63], MK[64, 127], MK[128, 128+L−1])

Here, MK[i, j] is a byte series r with a length of (j−i+1) bytes from the beginning i-th byte to the beginning j-th byte of MK. Here, the 0-th byte is assumed to be the beginning type.

Here, attr_a or attr_b may include an EAP channel binding parameter, the apparatus capability, the operational credential, or the like. Further, the EAP channel binding is defined in, for example, http://tools.ietf.org/html/draft-ietf-emu-chbind-11. Further, attr_a or attr_b may include an encryption key used in encryption of a data link protocol such as IEEE 802.15.4 and an application layer protocol such as the NTP, and attributes such as a key ID subordinate to the encryption key, a key lifetime, and a replay counter initial value.

IBE#1 may include an elliptic curve indicator supported by the EAP peer and a list of hash function identifiers used in calculation of Finished_P or Finished_S. In this case, IBE#2 may include an elliptic curve indicator supported commonly by the EAP peer and the EAP server and used in IBE#2, IBE#3, and IBE#4 or a hash function identifier.

The communication apparatus according to the first embodiment executes the bootstrap authentication process with the apparatus registration server based on the preset bootstrap credential. Thus, even when a push button is configured, the encrypted communication path can be established between the communication apparatus and the apparatus registration server. Accordingly, it is possible to prevent the MiTM attack in which a credential is wiretapped in a relay node:

### Second Embodiment

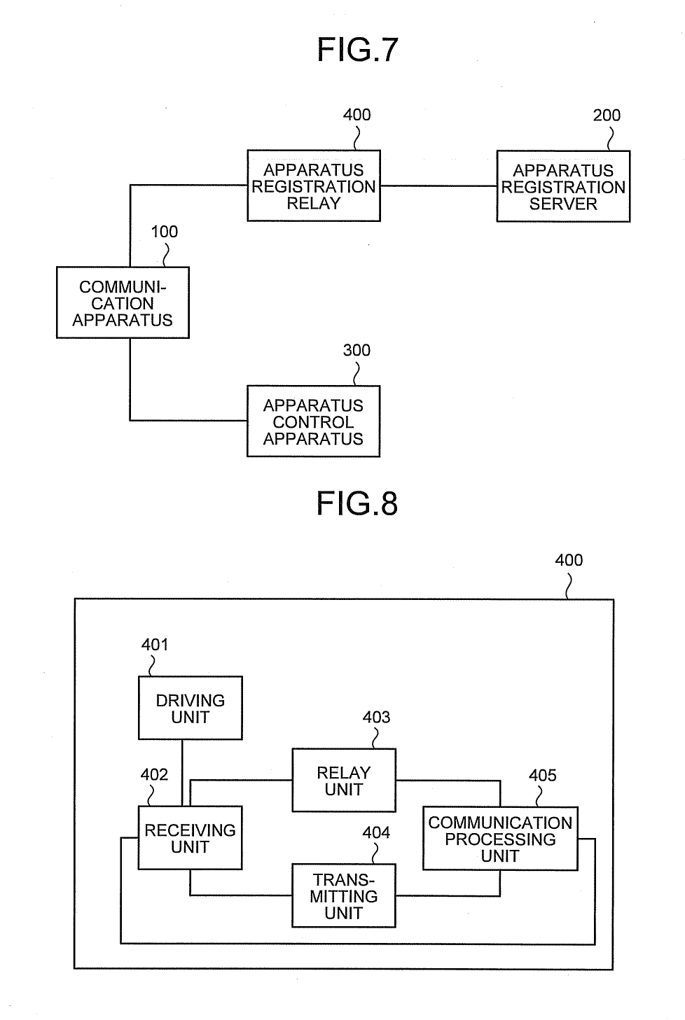

A communication system according to a second embodiment includes an apparatus registration relay that relays communication between a communication apparatus (electronic apparatus) and an apparatus registration server. FIG. 7 is a block diagram illustrating an example of the configuration of the communication system according to the second embodiment. As illustrated in FIG. 7, the communication system according to the second embodiment further includes an apparatus registration relay 400.

Since the configurations of a communication apparatus 100, an apparatus registration server 200, and an apparatus control apparatus 300 according to the second embodiment are the same as those of the first embodiment, the description thereof will not be repeated. Since a normal communication process between the communication apparatus 100 and the apparatus control apparatus 300 according to the second embodiment is the same as the process described with reference to FIG. 6, of the first embodiment, the description thereof will not be repeated.

The apparatus registration relay 400 may be mounted on a HEMS server or a smart meter. Each MAC layer and each physical layer between the communication apparatus 100 and the apparatus registration server 200, and the apparatus registration relay 400 may be realized in conformity with a communication protocol such as a wired LAN, a wireless LAN, Bluetooth (registered trademark), or ZigBee (registered trademark). Further, the bootstrap credential exchanged between the communication apparatus 100 and the apparatus registration server 200, and the apparatus registration relay 400 may be exchanged in conformity with a protocol of any layer of the data link layer, the network layer, the transport layer, and the application layer. When the authentication information is exchanged with the data link layer, a protocol such as IEEE 802.1X or IEEE 802.15.9 may be used. When the authentication information is exchanged in conformity with a protocol of an upper layer of the data link layer, RFC 6345 (PANA relay Element) may be used.

FIG. 8 is a block diagram illustrating an example of the configuration of the apparatus registration relay 400 according to the second embodiment. As illustrated in FIG. 8, the apparatus registration relay 400 includes a driving unit 401, a receiving unit 402, a relay unit 403, a transmitting unit 404, and a communication processing unit 405.

The communication processing unit 405 controls communication with an external apparatus in conformity with any communication protocol such as a wired LAN, a wireless LAN, Bluetooth (registered trademark), or ZigBee (registered trademark), as described above.

The driving unit 401 executes driving by hardware or software. The receiving unit 402 receives an execution instruction to execute a bootstrap authentication process. Since the configurations of the driving unit 401 and the receiving unit 402 are the same as those of the driving unit 101 and the receiving unit 102 of the communication apparatus 100, the description thereof will not be repeated.

The relay unit 403 relays the bootstrap authentication process executed between the communication apparatus 100 and the apparatus registration server 200. For example, when the relay unit 403 receives a push-button event from the driving unit 401 or the like, the relay unit 403 starts transmitting the bootstrap credential between the communication apparatus 100 and the apparatus registration server 200 through the communication processing unit 405. When the relay unit 403 receives the push-button event and then a given time elapses, the relay unit 403 ends the transmission of the bootstrap credential in spite of the fact that the bootstrap credential is being transmitted. When the transmitting unit 404 receives the push-button event, the transmitting unit 404 transmits the push-button event to the apparatus registration server 200 through the communication processing unit 405 using a secure communication channel.

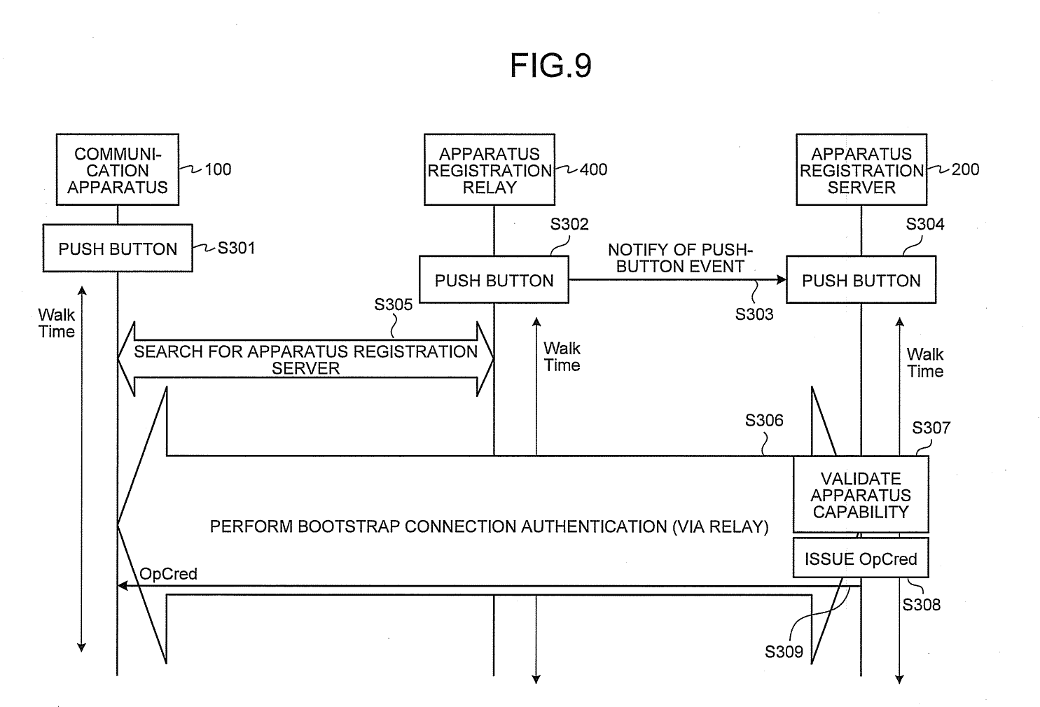

Next, the bootstrap communication process executed between the communication apparatus 100, the apparatus registration relay 400, and the apparatus registration server 200 having the above-described configurations according to the second embodiment will be described. FIG. 9 is a diagram illustrating a sequence of an example of the bootstrap communication process according to the second embodiment.

When the bootstrap buttons of the communication apparatus 100 and the apparatus registration relay 400 are driven through a user's operation, the receiving units 102 and 202 receive the execution instruction to execute the bootstrap authentication process (steps S301 and S302). Thereafter, the communication apparatus 100 and the apparatus registration relay 400 validate the transmission and reception of the bootstrap credential during a given time (Walk Time). Further, the transmitting unit 404 of the apparatus registration relay 400 transmits the push-button event to the apparatus registration server (step S303).

For example, when the push button is driven by software (step S304), the apparatus registration server 200 having received the push-button event validates the transmission and the reception of the bootstrap credential to and from the communication apparatus 100 via the apparatus registration relay 400 during a given time (Walk Time).

The communication apparatus 100 first executes a sequence for searching for an apparatus registration server in order to obtain a communicable address of the apparatus registration server 200 during a given time (step S305). The DHCP, the DNS, and the UPnP may be used to search for the apparatus registration server. In this embodiment, the address of the apparatus registration relay 400 is actually obtained as a communicable address of the apparatus registration server 200.

Thereafter, the communication apparatus 100 executes the bootstrap authentication process with the apparatus registration server 200 based on the bootstrap credential (BtCred) (step S306). Actually, a message for the bootstrap authentication process generated by the communication apparatus 100 is transmitted to the apparatus registration relay 400. Then, the relay unit 403 of the apparatus registration relay 400 transmits this message to the apparatus registration server 200. Then, the message for the bootstrap authentication process generated by the apparatus registration server 200 is transmitted to the apparatus registration relay 400. Then, the relay unit 403 of the apparatus registration relay 400 transmits this message to the communication apparatus 100.

Since step S307 to step S309 are the same as step S105 to step S107 of FIG. 5, the description thereof will not be repeated.

Further, a secure communication path is set in advance between the apparatus registration relay 400 and the apparatus registration server 200. The push-button event and the bootstrap credential are transmitted along the secure communication path. An encrypted logical channel such as a TLS session and an IPsec security association can be applied as the secure communication path.

In the communication system according to the second embodiment, the same processes as those of the first embodiment can be realized, even when the relay apparatus (apparatus registration relay) relaying the bootstrap authentication process is used.

### Third Embodiment

A communication system according to a third embodiment includes an apparatus (electronic apparatus) and an adapter instead of the communication apparatus. In this embodiment, the adapter corresponds to a relay apparatus that relays communication between the apparatus and an apparatus registration server.

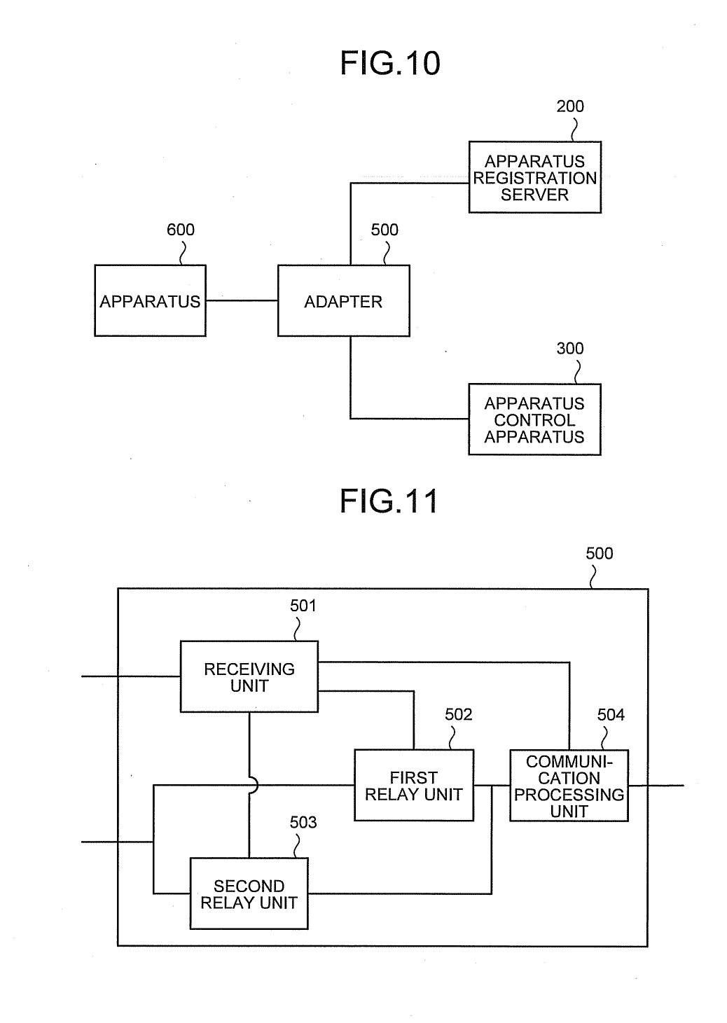

FIG. 10 is a block diagram illustrating an example of the configuration of the communication system according to the third embodiment. As illustrated in FIG. 10, the communication system according to the third embodiment further includes an apparatus 600 and an adapter 500.

Since the configurations of the apparatus registration server 200 and the apparatus control apparatus 300 according to the third embodiments are the same as those of the first embodiment, the description thereof will not be repeated.

The adapter 500 is arbitrarily detachably mounted on the apparatus 600 and is an apparatus that includes a connection unit simply connected to the apparatus 600 or a communication unit communicating with the apparatus 600. For example, a universal serial bus (USB), an RS-232C, or the like can be used as the connection unit or the communication unit. Further, the adapter 500 includes a communication unit communicating with the apparatus registration server 200 and the apparatus control apparatus 300. Various physical communication units such as a wired LAN, a wireless LAN, Bluetooth (registered trademark), and ZigBee (registered trademark) can be used in the communication of the communication unit, as in the communication apparatus of the first embodiment.

On the other hand, the single apparatus 600 is an apparatus that does not include a physical communication unit communicating with the apparatus registration server 200 or the apparatus control apparatus 300 and includes only a connection unit simply connected to the adapter 500 or a communication unit communicating with the adapter 500. For example, a USB, an RS-232C, or the like can be used as the connection unit or the communication unit, as in the adapter 500. The apparatus 600 is connected to the adapter 500 to communicate with the adapter 500 and to communicate with the apparatus registration server 200 and the apparatus control apparatus 300 through the physical communication unit included in the adapter 500. For example, when the adapter 500 including a wired LAN is connected to the apparatus 600, the apparatus 600 can communicate with the apparatus registration server 200 through the wired LAN. Further, when the adapter 500 including a wireless LAN is connected to the apparatus 600, the apparatus 600 can communicate with the apparatus registration server 200 through the wireless LAN. One or both of the apparatus 600 and the adapter 500 may include a unit corresponding to the bootstrap button described in the first embodiment.

FIG. 11 is a block diagram illustrating an example of the configuration of the adapter 500 according to the third embodiment. As illustrated in FIG. 11, the adapter 500 includes a receiving unit 501, a first relay unit 502, a second relay unit 503, and a communication processing unit 504.

The receiving unit 501 receives an execution instruction to execute the bootstrap authentication process. For example, the receiving unit 501 receives a user's operation on a push button or the like included in the adapter 500, detection of physical connection with the apparatus 600, or notification of a bootstrap driving event from the apparatus 600 as start (execution instruction) of the bootstrap authentication process. When the receiving unit 501 receives the execution instruction, the receiving unit 501 transmits the bootstrap driving event to the communication processing unit 504, the first relay unit 502, and the second relay unit 503. The receiving unit 501 may transmit the bootstrap driving event to the apparatus 600 connected to the adapter 500.

The communication processing unit 504 controls communication with an external apparatus in conformity with any communication protocol such as a wired LAN, a wireless LAN, Bluetooth (registered trademark), or ZigBee (registered trademark). When the communication processing unit 504 receives the bootstrap driving event, the communication processing unit 504 executes an operation of detecting the apparatus registration server. When the communication processing unit 504 detects the apparatus registration server 200, the communication processing unit 504 notifies the apparatus 600 connected to the adapter 500 of the detection of the apparatus registration server 200 via the first relay unit 502.

The first relay unit 502 transmits the bootstrap credential between the apparatus 600 and the apparatus registration server 200 through the communication processing unit 504. When the bootstrap driving event is received, the bootstrap credential starts to be transmitted. Then, when a given time elapses after the reception of the bootstrap driving event, the transmission of the bootstrap credential is ended in spite of the fact that the bootstrap credential is being transmitted.

The second relay unit 503 transmits the operational credential between the apparatus 600 and the apparatus registration server 200 through the communication processing unit 504. The operational credential may be transmitted, only when the apparatus 600 retains the operational credential and is not connected to the apparatus control apparatus 300. Further, when the bootstrap driving event is received, the operational credential may be prohibited from being transmitted during a given time.

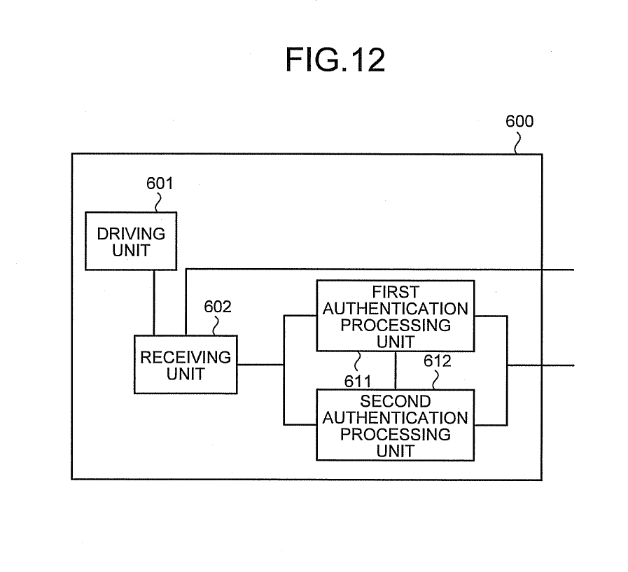

FIG. 12 is a block diagram illustrating an example of the configuration of the apparatus 600 according to the third embodiment. As illustrated in FIG. 12, the apparatus 600 includes a driving unit 601, a receiving unit 602, a first authentication processing unit 611, and a second authentication processing unit 612.

The driving unit 601 executes driving by hardware or software. Since the configuration of the driving unit 601 is the same as that of the driving unit 101 of the communication apparatus 100, the description thereof will not be repeated.

The receiving unit 602 receives a user's operation on the driving unit 601, detection of physical connection with the adapter 500, or notification of the bootstrap driving event from the adapter 500 as start (execution instruction) of the bootstrap authentication process. When the receiving unit 602 receives the execution instruction, the receiving unit 602 transmits the bootstrap driving event to the first authentication processing unit 611 and the second authentication processing unit 612. The receiving unit 602 may transmit the bootstrap driving event to the adapter 500 connected to the apparatus 600.

When the first authentication processing unit 611 receives the bootstrap driving event and a notification of the apparatus registration server found by the adapter 500, the first authentication processing unit 611 starts the bootstrap authentication process with the apparatus registration server 200 through the adapter 500. When the bootstrap authentication process successfully ends, the first authentication processing unit 611 transmits, to the second authentication processing unit 612, the operation credential acquired from the apparatus registration server 200 through the adapter 500. When the first authentication processing unit 611 receives the bootstrap driving event and a given time elapses, the first authentication processing unit 611 ends the bootstrap authentication process in spite of the fact that the bootstrap authentication process is being executed.

When the second authentication processing unit 612 retains the operational credential and is not connected to the apparatus control apparatus 300, the second authentication processing unit 612 starts the communication authentication process. Further, when the bootstrap driving event is received, the operational credential is prohibited from being transmitted during a given time and the executed communication authentication process immediately ends.

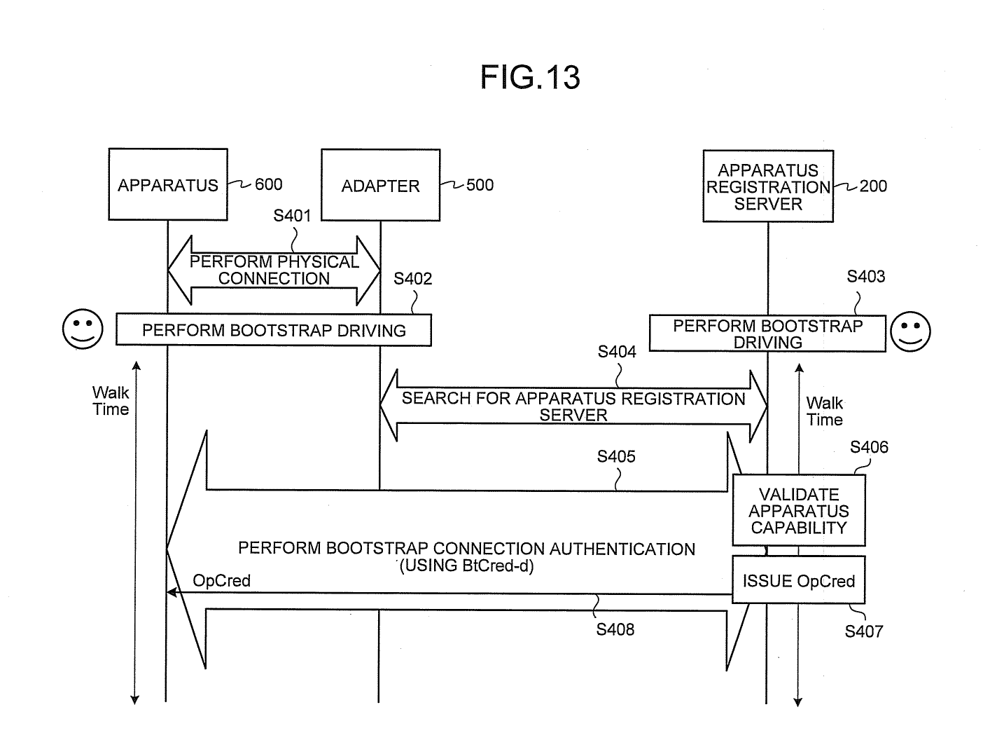

Next, the bootstrap communication process executed among the apparatus 600, the adapter 500, and the apparatus registration server 200 having the above-described configurations according to the third embodiment will be described. FIG. 13 is a diagram illustrating a sequence of an example of the bootstrap communication process according to the third embodiment.

In the third embodiment, for example, an operation is exemplified in which the bootstrap authentication process between the apparatus 600 and the apparatus registration server 200 is executed after the apparatus 600 and the adapter 500 are connected by the user.

First, the apparatus 600 and the adapter 500 are connected physically by the user (step S401). Next, the user sets the apparatus 600 and the adapter 500 to enter a bootstrap driving state. The receiving unit 602 receives, as an execution instruction to execute the bootstrap authentication process, the fact that the bootstrap driving state is set by the user's operation (step S402).

In the bootstrap driving, a push button or the like (the driving unit 601 or the like) included in the apparatus 600 or the adapter 500 may be used. Further, the fact that the user connects the apparatus 600 to the adapter 500 may be considered as a trigger of the bootstrap driving. Furthermore, the user may operate the push buttons or the like of both the apparatus 600 and the adapter 500. The bootstrap driving executed by the user's operation on only one of the apparatus 600 and the adapter 500 may be transferred to the adapter 500 or the apparatus 600 connected thereto.

The user operates the push button or the like of the apparatus registration server 200 such that the apparatus registration server 200 enters the bootstrap driving state. The receiving unit 202 of the apparatus registration server 200 receives, as an execution instruction to execute the bootstrap authentication process, the fact that the bootstrap driving state is set by the user's operation (step S403).

When the bootstrap driving state is set, the apparatus 600 and the apparatus registration server 200 validate the transmission and reception of the bootstrap credential during a given period (Walk Time). Further, the adapter 500 permits the bootstrap credential to be relayed only during the given time.

In the bootstrap driving state, the adapter 500 first executes a sequence for detecting an apparatus registration server (step S404). The minimum information necessary in the communication executed for the adapter 500 to detect the apparatus registration server is set in advance, for example, in the adapter 500.

When the adapter 500 detects the apparatus registration server 200, the apparatus 600 executes the bootstrap authentication process with the apparatus registration server 200 through the adapter 500 based on the bootstrap credential (steps S405, S406, and S407). The bootstrap credential used at this time includes information used to specify the apparatus capability retained by the apparatus 600. The authentication order is the same as that of the first embodiment.

When the authentication of the apparatus capability succeeds, the apparatus 600 receives the operational credential issued by the apparatus registration server 200 through the adapter 500 (step S408) and the apparatus 600 retains the operational credential. Here, the bootstrap authentication process successfully ends.

A communication operation between the apparatus 600 and the adapter 500, and the apparatus control apparatus 300 after the acquisition of the operational credential from the apparatus registration server 200 will be described.

First, the adapter 500 or the apparatus 600 executes a sequence for detecting an apparatus control apparatus. The sequence for detecting an apparatus control apparatus may be executed only based on the minimum information retained in the adapter 500 or may be also executed based on the information retained in the apparatus 600. For example, as in the first embodiment, the DHCP, the DNS, and the UPnP may be used. Next, the apparatus 600 executes the communication authentication process between the apparatus 600 and the apparatus control apparatus 300 based on the operational credential retained in the apparatus 600. The subsequent sequence is the same as that of the first embodiment (FIG. 6).

In the third embodiment, the bootstrap authentication process is executed only between the apparatus 600 and the apparatus registration server 200, and the adapter 500 itself does not retain the operational credential. Therefore, a benefit can be obtained in the following case. For example, it is assumed that the adapter 500 is broken down after the apparatus 600 and the adapter 500 including Bluetooth (registered trademark) are physically connected to each other, and the bootstrap authentication process successfully ends between the apparatus 600 and the apparatus registration server 200. It is assumed that the adapter 500 is replaced with another adapter 500 including another physical communication unit such as another Bluetooth (registered trademark) or ZigBee (registered trademark). Even in this case, when the apparatus 600 remains in the same state, the control or the like of the apparatus control apparatus 300 can be executed in the state in which the communication authentication process is completed without the user being forced to execute the authentication sequence again.

### Fourth Embodiment

In the sequence of the third embodiment, there is a case in which the user is sometimes obliged to bear the considerable burden of the operations. In a communication system according to a fourth embodiment, this burden is lifted. For example, a case will be described in which the bootstrap authentication process is executed between an air conditioner apparatus and the adapter 500 installed in the third floor of a house and a HEMS server that has the function of the apparatus registration server 200 installed in the first floor. In this case, in the sequence of the third embodiment, the user is required to operate a push button or the like of the HEMS server on the first floor, move to the third floor in a hurry (within a given time), and then operate a push button or the like of the air conditioner apparatus. In the sequence of the fourth embodiment, the user detaches the adapter 500 from the air conditioner apparatus, carries the adapter 500, and operates the push button or the like of the HEMS server of the first floor and the push button or the like of the adapter 500 to execute the bootstrap authentication process of the adapter 500 once. Thereafter, the user moves to the third floor slowly (irrespective of the given time) and mounts the adapter 500 on the air conditioner apparatus. Then, the bootstrap authentication process is completed between the air conditioner apparatus and the apparatus registration server 200 through the authenticated adapter 500.

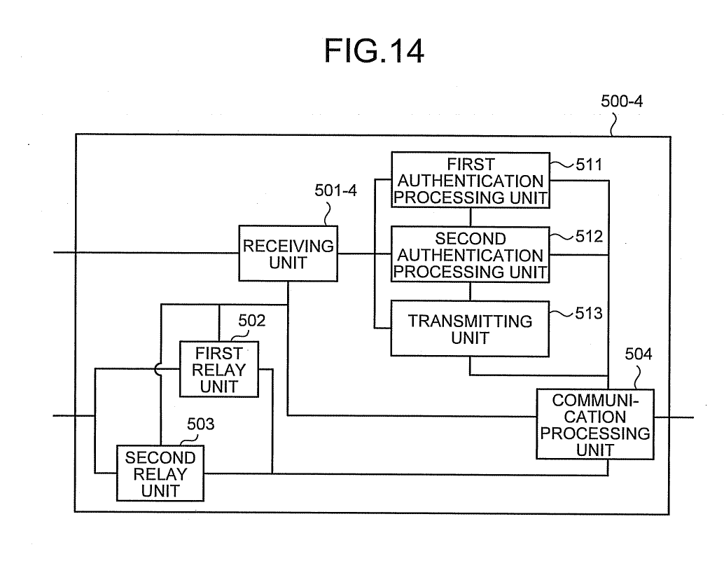

FIG. 14 is a block diagram illustrating an example of the configuration of an adapter 500-4 according to the fourth embodiment. As illustrated in FIG. 14, the adapter 500-4 includes a receiving unit 501-4, a first relay unit 502, a second relay unit 503, a communication processing unit 504, a first authentication processing unit 511, a second authentication processing unit 512, and a transmitting unit 513.

Since the functions of the first relay unit 502, the second relay unit 503, and the communication processing unit 504 are the same as those of the third embodiment, the description thereof will not be repeated.

The receiving unit 501-4 receives the execution instruction to execute the bootstrap authentication process. When the receiving unit 501-4 receives the execution instruction and the adapter 500-4 is not connected to the apparatus 600, the receiving unit 501-4 transmits a bootstrap driving event to the first authentication processing unit 511 and the second authentication processing unit 512. When the adapter 500-4 is connected to the apparatus 600, the receiving unit 501-4 transmits the bootstrap driving event to the transmitting unit 513, the first relay unit 502, and the second relay unit 503. The receiving unit 501-4 may transmit the bootstrap driving event to the apparatus 600 connected to the adapter 500-4 and the apparatus registration server 200.

When the first authentication processing unit 511 receives the bootstrap driving event, the first authentication processing unit 511 starts the bootstrap authentication process of the adapter 500-4 with the apparatus registration server 200 through the communication processing unit 504. When the bootstrap authentication process of the adapter 500-4 successfully ends, the first authentication processing unit 511 transmits the operational credential acquired from the apparatus registration server 200 to the second authentication processing unit 512. When a given time elapses after the reception of the bootstrap driving event, the bootstrap authentication process of the adapter 500-4 ends in spite of the fact that the bootstrap authentication process is being executed.

The second authentication processing unit 512 retains the operational credential. When the adapter 500-4 is not connected to the apparatus control apparatus 300, the second authentication processing unit 512 starts the communication authentication process through the communication processing unit 504. Further, when the bootstrap driving event is received, the operational credential may be prohibited from being transmitted during a given time and the communication authentication process immediately ends in spite of the fact that the communication authentication process is being executed.

When the bootstrap driving event is received, the transmitting unit 513 establishes a secure communication path with the apparatus registration server 200 based on the operational credential retained by the second authentication processing unit 512. The transmitting unit 513 transmits the bootstrap driving event to the apparatus registration server 200 through the communication processing unit 504 along the established secure communication path.

The apparatus 600 of the fourth embodiment is the same as the apparatus 600 (FIG. 12) of the third embodiment. The adapter 500-4 of the fourth embodiment includes the function of the adapter 500 of the third embodiment. Accordingly, the adapter 500-4 of the fourth embodiment can execute the sequence of the third embodiment, that is, can execute the authentication operation after the apparatus 600 and the adapter 500-4 are connected.

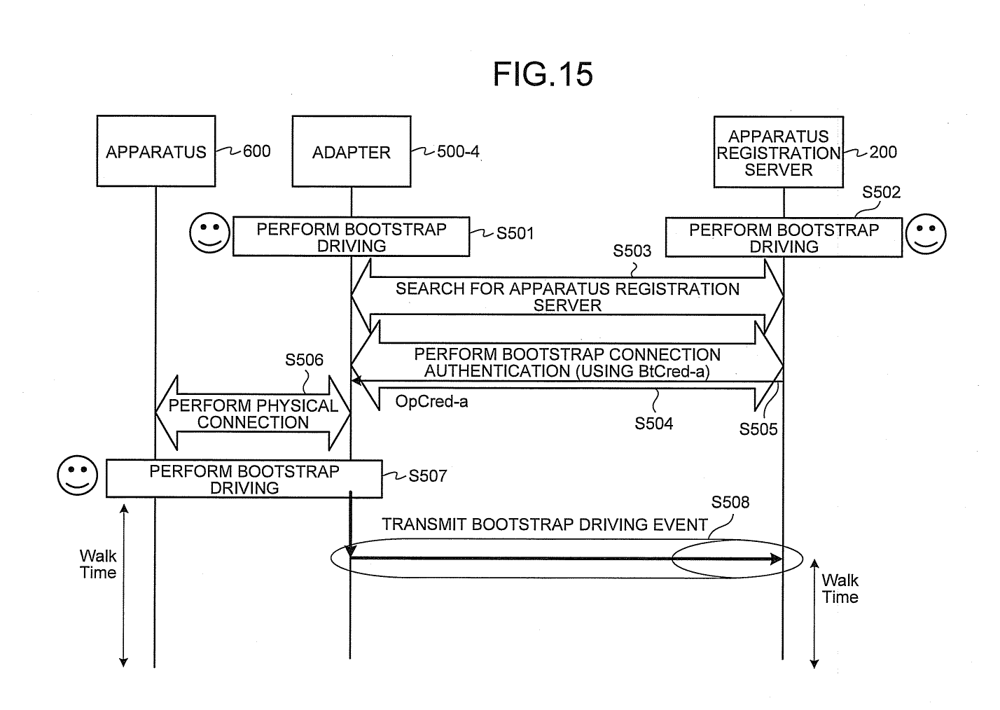

Next, the bootstrap communication process executed between the apparatus 600 and the adapter 500-4, and the apparatus registration server 200 having the above-described configurations according to the fourth embodiment will be described. FIG. 15 is a diagram illustrating a sequence of an example of the bootstrap communication process according to the fourth embodiment. In the fourth embodiment, an operation is exemplified when the apparatus 600 and the adapter 500-4 are not connected and the sequence of the bootstrap authentication process is started.

The user sets the adapter 500-4 detached from the apparatus 600 and the apparatus registration server 200 to enter a bootstrap driving state. The receiving unit 501-4 of the adapter 500-4 and the receiving unit 202 of the apparatus registration server 200 receive, as an execution instruction to execute the bootstrap authentication process, the fact that the bootstrap driving state is set by the user's operation (step S501 and step S502).

In the bootstrap driving, a push button or the like included in the apparatus registration server 200 or the adapter 500-4 may be used. Further, the temporal physical connection made using a USB, an RS-232C, or the like or correspondence formed by an infrared ray or a short-range wireless communication between the apparatus registration server 200 and the adapter 500-4 may be considered as a trigger of the bootstrap driving.

Further, the adapter 500-4 may include a storage battery and may be singly activated only during the bootstrap execution. The adapter 500-4 may be configured to receive power for activation through the physical connection (USB or the like) with the apparatus registration server 200.

In the bootstrap driving state, the adapter 500-4 searches for the apparatus registration server (step S503). The adapter 500-4 executes the bootstrap authentication process with the apparatus registration server 200 based on a bootstrap credential (BtCred-a) retained by the adapter 500-4 (step S504). The sequence of the bootstrap authentication process is the same as that of the first embodiment.

The adapter 500-4 retains an operational credential (OpCred-a) issued by the apparatus registration server 200 in the adapter 500-4 when the validation of the capability of the adapter 500-4 succeeds (step S505). Thus, the bootstrap authentication process of the adapter 500-4 successfully ends.

Next, the user connects the adapter 500-4 to the apparatus 600 (step S506), and then sets the apparatus 600 and the adapter 500-4 to enter the bootstrap driving state. The receiving unit 602 of the apparatus 600 receives, as an execution instruction to execute the bootstrap authentication process, the fact that the bootstrap driving state is set by the user's operation (step S507). In the bootstrap driving, the various methods described in the third embodiment can be used.

When the adapter 500-4 enters the bootstrap driving state, the adapter 500-4 establishes the secure communication path with the apparatus registration server 200 based on the operational credential (OpCred-a) obtained previously through the bootstrap authentication process of the adapter 500-4. The adapter 500-4 transmits the bootstrap driving event to the apparatus registration server 200 along the established secure communication path (step S508). As in the second embodiment, the apparatus registration server 200 having received the bootstrap driving event validates the transmission and reception of the bootstrap credential during a given period, when the push button is driven by software.

Thus, the apparatus 600, the adapter 500-4, and the apparatus registration server 200 enter the bootstrap driving state. Thereafter, the bootstrap authentication process is executed between the apparatus 600 and the apparatus registration server 200 in the same sequence as that of the third embodiment (not illustrated).

In the case of the bootstrap authentication process, a bootstrap credential (BtCred-d) retained by the apparatus 600 is used. Further, since the sequence for searching for an apparatus registration server according to the third embodiment is already performed in the fourth embodiment, the sequence for searching an apparatus registration server may not be executed. Thereafter, the same sequence as that of the third embodiment is also executed for the communication operation between the apparatus 600 and the adapter 500-4, and the apparatus control apparatus 300.

### Fifth Embodiment

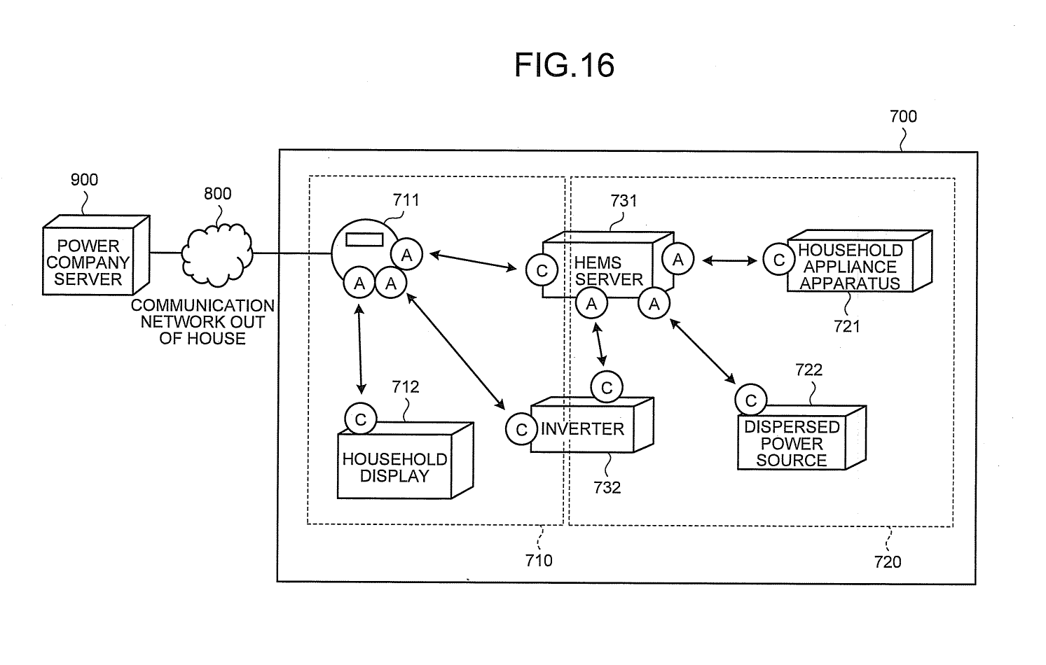

In a fifth embodiment, a case in which a communication system is configured as a household network will be described. FIG. 16 is a block diagram illustrating an example of the configuration of the communication system according to the fifth embodiment.

A household network 700 as the communication system includes a network 710 and another network 720. The network 710 is a network in which a smart meter 711, a household display 712, a HEMS server 731, and an inverter 732 are connected to each other.

As illustrated in FIG. 16, the smart meter 711 may be connected to a power company server 900 via a communication network 800 out of a house. The network 720 is a network in which the HEMS server 731, the inverter 732, a household appliance apparatus 721, and a dispersed power source 722 are connected to each other. Examples of the dispersed power source 722 include a storage battery, a solar panel, and an electrical vehicle.

The networks 710 and 720 may be a ZigBee smart energy (version 1.X or version 2.X) network or an ECHONET (registered trademark) Lite network. IEEE 802.15.4, PLC, or Wi-Fi may be used in the data link layers of the networks 710 and 720.

In the network 710, for example, the smart meter 711 corresponds to the apparatus registration relay and the apparatus control apparatus described in the embodiments. Further, the household display 712, the HEMS server 731, and the inverter 732 correspond to the communication apparatus described in the embodiments.

In the network 720, the functions of the apparatus registration server and the apparatus control apparatus described in the embodiments may be mounted on the HEMS server 731. Further, the function of the communication apparatus described in the embodiments is mounted on the household appliance apparatus 721, the inverter 732, and the dispersed power source 722. The dispersed power source 722 is connected to the inverter 732 via a DC power line (not illustrated). The inverter 732 performs DC-AC conversion.

Apparatuses (the HEMS server 731 and the inverter 732) connected to both the networks 710 and 720 may be connected to the networks using different communication interfaces. Further, the apparatuses connected to both the networks 710 and 720 are prohibited from transmitting packets of the lower layers of the IP layer between the networks 710 and 720.

The networks 710 and 720 use RFC 5191 (PANA) as a connection authentication protocol. In the network 710, a PANA authentication agent function is mounted on the smart meter 711. A PANA client function is mounted on the household display 712, the HEMS server 731, and the inverter 732. In FIG. 16, A and C enclosed by circles indicate the PANA authentication agent function and the PANA client function, respectively. Further, the arrows indicate network connection in which the PANA authentication agent function and the PANA client function are connected to each other.

In the network 710, the bootstrap credential necessary to execute the bootstrap authentication process between the smart meter 711 and each communication apparatus may be remotely set in the smart meter 711 from the power company server 900 via the communication network 800 out of the house. The bootstrap driving of the smart meter 711 is executed by a remote command from the power company server 900 via the communication network 800 out of the house. In the network 710, each communication apparatus acquires the operational credential from the smart meter 711, and then acquires meter data or a demand response signal from the smart meter 711. In the network 720, each communication apparatus acquires the operational credential from the HEMS server 731, and then is controlled by the HEMS server 731.

According to the first to fifth embodiments, as described above, an encrypted communication path can be established between a communication apparatus and an apparatus registration server, even when a push button is configured. Accordingly, it is possible to prevent the MiTM attack in which a credential is wiretapped in a relay node.

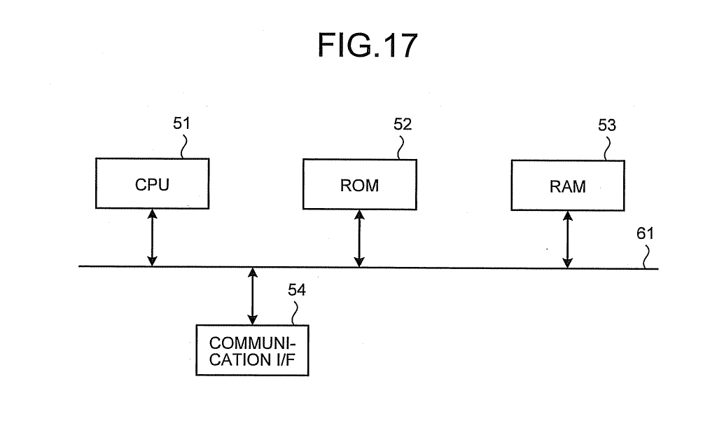

Next, a hardware configuration of each apparatus (the communication apparatus, the apparatus registration server, the apparatus control apparatus, and the adapter) according to the first to fifth embodiments will be described with reference to FIG. 17. FIG. 17 is a diagram illustrating an example of a hardware configuration of each apparatus according to the first to fifth embodiments.

Each apparatus according to the first to fifth embodiments includes a control apparatus such as a central processing unit (CPU) 51, a storage device such as a read-only memory (ROM) 52 or a random access memory (RAM) 53, a communication I/F 54 connected to a network for communication, and a bus 61 connecting the units to each other.

Programs executed in the apparatuses according to the first to fifth embodiments are embedded in advance in the ROM 52 or the like to be provided.

The programs executed in the apparatuses according to the first to fifth embodiments may be recorded as files with an installation-enabled format or an executable format in a computer-readable recording medium such as a compact disk read-only memory (CD-ROM), a flexible disc (FD), a compact disk recordable (CD-R), and a digital versatile disk (DVD) to be provided as a computer program product.

The programs executed in the apparatuses according to the first to fifth embodiments may be stored in a computer connected to a network such as the Internet and may be downloaded via the network to be provided. Further, the programs executed in the apparatuses according to the first to the fifth embodiments may be provided or distributed in a network such as the Internet.

The programs executed in the apparatuses according to the first to the fifth embodiments may cause a computer to function as the units of the communication apparatus described above. A CPU 51 of this computer can read and execute the programs from a computer-readable storage medium on a main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication apparatus connected to a server apparatus that issues first authentication information used in communication, comprising:
a receiving unit configured to receive an execution instruction to execute a bootstrap authentication process of issuing the first authentication information, the bootstrap authentication process including validation of capability information indicating a capability of the communication apparatus; and
a first authentication processing unit configured to execute the bootstrap authentication process with the server apparatus based on second authentication information including the capability information when the receiving unit receives the execution instruction.

2. The communication apparatus according to claim 1, wherein
the first authentication processing unit receives the first authentication information from the server apparatus when the bootstrap authentication process for the communication apparatus results in success, and
the communication apparatus further comprises a second authentication processing unit configured to execute a communication authentication process of communicating with an external apparatus with the external apparatus based on the received first authentication information.

3. The communication apparatus according to claim 1, wherein the second authentication information includes authentication information for identify-based encryption (IBE).

4. The communication apparatus according to claim 3, wherein the second authentication information includes the capability information in an ID of the IBE.

5. The communication apparatus according to claim 3, wherein the second authentication information includes a valid period in an ID of the IBE.

6. The communication apparatus according to claim 1, wherein the first authentication processing unit executes the bootstrap authentication process in conformity with one of IBE-based mutual authentication (IMA) protocol, extensible authentication protocol-IMA (EAP-IMA), and a protocol for carrying authentication for network access (PANA).

7. The communication apparatus according to claim 1, wherein the second authentication information includes a symmetric key or a digital certificate.

8. A server apparatus connected to a communication apparatus, comprising:
a receiving unit configured to receive an execution instruction to execute a bootstrap authentication process of issuing first authentication information used in communication by the communication apparatus, the bootstrap authentication process including validation of capability information indicating a capability of the communication apparatus; and
an authentication processing unit configured to execute the bootstrap authentication process with the communication apparatus based on second authentication information acquired from the communication apparatus when the receiving unit receives the execution instruction, the second authentication information including the capability information.

9. The server apparatus according to claim 8, wherein the authentication processing unit transmits the first authentication information to the communication apparatus when the bootstrap authentication process for the communication apparatus in the authentication processing unit results in success.

10. A relay apparatus connected to an electronic apparatus and a server apparatus that issues first authentication information used in communication, comprising:
a receiving unit configured to receive an execution instruction to execute a bootstrap authentication process of issuing the first authentication information, the bootstrap authentication process being executed between the server apparatus and an electronic apparatus and including validation of capability information indicating a capability of the electronic apparatus; and
a relay unit configured to relay the bootstrap authentication process executed between the server apparatus and the electronic apparatus based on second authentication information including the capability information when the receiving unit receives the execution instruction.

11. The relay apparatus according to claim 10, wherein
the receiving unit further receives an execution instruction to execute a bootstrap authentication process of issuing third authentication information used in communication between the relay apparatus and the server apparatus, and
the relay apparatus further comprises:
an authentication processing unit configured to execute the bootstrap authentication process of issuing the third authentication information with the server apparatus based on fourth authentication information when the receiving unit receives the execution instruction of the bootstrap authentication process of issuing the third authentication information; and
a transmitting unit configured to transmit an execution instruction to execute the bootstrap authentication process of issuing the first authentication information to the server apparatus by the communication established based on the third authentication information.

12. A control apparatus connected to a communication apparatus, comprising:
an authentication processing unit configured to execute a communication authentication process including validation of capability information with the communication apparatus based on authentication information including the capability information indicating a capability of the communication apparatus.

13. A computer program product comprising a computer-readable medium containing a program executed by a processor of a communication apparatus connected to a server apparatus that issues first authentication information used in communication, the program causing the computer to execute:
receiving an execution instruction to execute a bootstrap authentication process of issuing the first authentication information, the bootstrap authentication process including validation of capability information indicating a capability of the communication apparatus; and
executing the bootstrap authentication process with the server apparatus based on second authentication information including the capability information when the receiving the execution instruction.

14. A computer program product comprising a computer-readable medium containing a program executed by a processor of a server apparatus connected to a communication apparatus, the program causing the computer to execute:
receiving an execution instruction to execute a bootstrap authentication process of issuing first authentication information used in communication by the communication apparatus, the bootstrap authentication process including validation of capability information indicating a capability of the communication apparatus; and
executing the bootstrap authentication process with the communication apparatus based on second authentication information acquired from the communication apparatus when receiving the execution instruction, the second authentication information including the capability information.

15. A computer program product comprising a computer-readable medium containing a program executed by a processor of a relay apparatus connected to an electronic apparatus and a server apparatus that issues first authentication information used in communication, the program causing the computer to execute:
receiving an execution instruction to execute a bootstrap authentication process of issuing the first authentication information, the bootstrap authentication process being executed between the server apparatus and the electronic apparatus and including validation of capability information indicating a capability of the electronic apparatus; and
relaying the bootstrap authentication process executed between the server apparatus and the electronic apparatus based on second authentication information including the capability information when receiving the execution instruction.

16. A computer program product comprising a computer-readable medium containing a program executed by a processor of a control apparatus connected to a communication apparatus, the program causing the computer to execute:
a communication authentication process including validation of capability information with the communication apparatus based on authentication information including the capability information indicating a capability of the communication apparatus.
